(19) United States
(12) Patent Application Publication
(10) Pub. No.: US 2024/0127368 A1
(43) Pub. Date: Apr. 18, 2024

(54) NON-PARAMETRIC METHODS OF RESOURCE ALLOCATION

(71) Applicant: Microsoft Technology Licensing, LLC, Redmond, WA (US)

(72) Inventor: Firas Hamze, Vancouver, CA (US)

(73) Assignee: Microsoft Technology Licensing, LLC, Redmond, WA (US)

(21) Appl. No.: 17/932,967

(22) Filed: Sep. 16, 2022

(51) Int. Cl. G06Q 50/06; G06F 17/18; G06Q 10/06

(52) U.S. Cl. CPC G06Q 50/06; G06F 17/18; G06Q 10/0635

(57) ABSTRACT

A general methodology is presented for optimizing a value at risk (VaR) associated with an allocation of objects (i.e., a strategy) having variable performance and loss characteristics. For purposes of illustration, investment strategies prescribing a portfolio of items from a set of candidates with unknown and generally correlated joint losses are discussed. The framework is based on approximating the VaR using nonparametric estimates of the portfolio loss density and, using mathematical insights, an efficient approach to computing the VaR gradient with respect to the strategy. The approach also allows inclusion of constraints on the strategy (e.g. a maximum fraction per item) and allows the VaR optimization problem to be solved using optimization techniques such as sequential quadratic programming.

### FIELD OF THE DISCLOSURE

The disclosure pertains to allocation and selection of resources such as networking or power generation to enhance performance.

### BACKGROUND

Managing risk when selecting operational settings of multiple objects and systems having probabilistically variable performance and failure characteristics is an important goal in many real world applications. For example, large scale electrical power distribution can require power from multiple generators with differing power generation and failure characteristics that can be correlated or uncorrelated. For any overall selection of generation systems, it is desirable to estimate the expected maximum risk of power loss or generation system failure or downtimes. For any overall characteristics, it is generally preferred to make selections having the lowest overall risk. Conventional approaches tend to be computationally slow and improved approaches are needed.

### SUMMARY

Allocation methods compriseobtaining an objective function associated with resource allocation risk and selecting an acceptable value of risk. Weights associated with the resource allocation are logistically parametrize, a gradient of the objective function is estimated based on a ratio of a derivative of a cumulative density to a loss density. A preferred allocation is obtained based on the estimated gradient and the acceptable value of risk. In some examples, the preferred allocation is obtained using sequential quadratic programming based on the objective function and the gradient of the objective function. In additional examples, the resource allocation is based on K resources with respective weights wₗ for i=1, . . . , K, wherein l and K are positive integers and the weights are parametrized as:

$${w}_{l} ( θ ) = \{ \begin{matrix}\frac{{e}^{{θ}_{l}}}{{\sum }_{{l}^{′} = 1}^{K - 1} {e}^{{θ}_{{l}^{′}}} + 1} & for l \leq K - 1 \\ \frac{1}{{\sum }_{{l}^{′} = 1}^{K - 1} {e}^{{θ}_{{l}^{′}}} + 1} & for l = K\end{matrix}$$

wherein θ is set of K real numbers.

In additional examples, the derivative of the objective function is based on differentiation with respect to θ. In still further examples, the estimating the gradient of the objective function is based on transformed losses associated with each of the resources. In some examples, losses yₗ are transformed based on a logarithm function as log(yₗ) or based on a hyperbolic arc sinh function as arc sinh(yₗ). In some examples, the allocation strategy is defined by an integer number K of weights w for each of K items as:

$$w = ( {w}_{1} , … , {w}_{K} ) \\ {w}_{n} \geq 0 for n ∈ \{ 1 , … , K \} \\ {\sum }_{n = 1}^{K} {w}_{n} = 1$$

wherein wₙ specifyies an allocation fraction dedicated to item n. In further examples, losses associated with each of the K items are defined by respective elements of a K-dimensional random variable L=(L₁, . . . , L_{K}). According to some examples, a weighted allocation loss Y is defined by Y=Σₙ₌₁^{K}wₙLₙ and the preferred allocation is selected to minimize the weighted allocation loss Y. In some alternatives, the resources are power generation resources or network communication resources with respective risks associated with power shortfall and data loss.

Allocation systems comprise at least one processor; and at least one computer readable storage medium having stored thereon processor-executable instructions to cause the processor to: obtain an objective function associated with resource allocation risk; logistically parametrize weights associated with the resource allocation; estimate a gradient of the objective function based on a ratio of a derivative of a cumulative density to a loss density; and obtain a preferred allocation based on the estimated gradient and the acceptable value of risk. In some examples, the at least one computer readable storage medium has stored thereon processor-executable instructions to cause the processor to obtain the preferred allocation using sequential quadratic programming. In some examples, the at least one computer readable storage medium has stored thereon processor-executable instructions to cause the processor to obtain the resource allocation of K resources with respective weights wₗ for i=1, . . . , K, wherein l and K are positive integers and the weights are parameterized as:

$${w}_{l} ( θ ) = \{ \begin{matrix}\frac{{e}^{{θ}_{l}}}{{\sum }_{{l}^{′} = 1}^{K - 1} {e}^{{θ}_{{l}^{′}}} + 1} & for l \leq K - 1 \\ \frac{1}{{\sum }_{{l}^{′} = 1}^{K - 1} {e}^{{θ}_{{l}^{′}}} + 1} & for l = K\end{matrix}$$

wherein θ is set of K real numbers. In further examples, the at least one computer readable storage medium has stored thereon processor-executable instructions to cause the processor to obtain the derivative of the objective function based on differentiation with respect to θ. In some alternatives, the at least one computer readable storage medium has stored thereon processor-executable instructions to cause the processor to estimate the gradient of the objective function is based on transformed losses associated with each of the resources. In some alternatives, Yₗ are transformed based on a logarithm function as log(yₗ) or based on a hyperbolic arc sinh function as arc sinh(yₗ). In some examples, the allocation strategy is defined by an integer number K of weights for each of K items as

$$w = ( {w}_{1} , … , {w}_{K} ) \\ {w}_{n} \geq 0 for n ∈ \{ 1 , … , K \} \\ {\sum }_{n = 1}^{K} {w}_{n} = 1$$

wherein wₙ specifies an allocation fraction dedicated to item n; losses associated with each of the K items are defined by respective elements of a K-dimensional random variable L=(L₁, . . . , L_{K}); a weighted allocation loss Y is defined by

$$Y = {\sum }_{n = 1}^{K} {w}_{n} {L}_{n} ;$$

and the preferred allocation is selected to minimize the weighted allocation loss Y. In further examples, the resources are power generation resources or network communication resources with respective risks associated with power shortfall and data loss.

These and other features are described below with respect to the accompanying drawings.

### BRIEF DESCRIPTION OF THE DRAWINGS

FIG. 1 illustrates a representative method.

FIG. 2 illustrates another representative method.

FIG. 3 illustrates a representative computing environment implementing the disclosed methods.

### DETAILED DESCRIPTION

### 1 Introduction

As discussed above, managing risk when selecting operational settings of multiple objects and systems can be an important goal in a variety of contexts such as distributed power generation, network resource allocation, and others. It is generally desired to make selections having the lowest overall risk consistent for overall system goals. For convenient explanation, the disclosed approaches are discussed with reference to investment decisions and investment portfolios based on financial instruments as the problems addressed in such a context typically appear more familiar. As used herein, the term “portfolio” refers to a set of objects, systems, or other items having randomly variable performances, whether intrinsically or in response to users or other demands.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

### 1.1 Preliminaries

Risk management can be associated with a commonly-used (if not uncontroversial) metric of risk is called Value At Risk (VaR). Given a random variable Y∈ [symbol] associated with the loss of a selected investment portfolio, the value at risk with level a is the smallest value of Y such that the probability of incurring a loss of less than or equal to that value is at least 1−α. Mathematically, if the loss cumulative distribution function (CDF) is

$${F}_{Y} ( y ) {=}^{△} Pr ( Y \leq y ) \\ then \\ {y}_{α} = {VaR}_{α} ( Y ) {=}^{△} {inf}_{y ∈ ℝ} \{ y : {F}_{Y} ( y ) \geq 1 - α \}$$

This somewhat technical-looking definition is constructed to ensure that the VaR is well-defined in case F_{Y} contains jump discontinuities or is not monotone (strictly increasing) over some subset of the loss domain. It is assumed herein that F_{Y} is both continuous and monotone, in which case the VaR is defined as the inverse of the CDF at 1−α, i.e

y_{α}=VaR_{α}(Y)=F_{Y}⁻¹(1−α)

In other words, the VaR in this regime simply corresponds to the point at which the tail probability of Y is α.

In the portfolio optimization problem considered here, the loss Y obtains in response to an allocation strategy over a set of K investment items, the individual assets available for acquisition (e.g. stocks, bonds, or currency) with unknown and generally correlated loss values. More precisely, the allocation strategy is defined by the K mixing weights (points on the unit K−1-simplex)

$$w = ( {w}_{1} , … , {w}_{K} ) \\ {w}_{n} \geq 0 for n ∈ \{ 1 , … , K \} \\ {\sum }_{n = 1}^{K} {w}_{n} = 1 \qquad ( 1 )$$

with wₙ specifying the fraction of the investor's budget to be dedicated to item n, while the K-dimensional random variable L=(L₁, . . . , L_{K}) distributed as

L˜f_{L}

quantifies the set of individual item losses; the (univariate) portfolio loss associated with strategy w is consequently given by the weighted aggregation of the item losses

$$Y = {\sum }_{n = 1}^{K} {w}_{n} {L}_{n} \qquad ( 2 )$$

Disclosed herein is a concurrent scheme for estimating the portfolio loss density ƒ_{Y}(.|w) nonparametrically, that is without any assumptions on its form, while optimizing over w so as to minimize the point at which the tail probability of the estimate is α.

### 1.2 VaR Optimization

In its abstract formulation, the optimization task is: given a risk level α and joint loss density ƒ_{L}, select w to so as to minimize VaRα(Y|w). In addition, required inequality constraints on the allocation strategies may be incorporated; for example, an investment strategy may demand that no more than a certain percentage of each item may be held ({wₙ≤k} for appropriate threshold k), or that a minimum fraction of items in a set of predefined sectors (e.g. energy or technology securities) be retained. These constraints can be represented as the system of N_{C} linear inequalities

Aw≤b

where A∈ [symbol] ^{N}^{_{C}}^{×K} and b∈ [symbol] ^{N}^{_{C}}. In the non-investment context, the constraints can be associated with power generation allocation to solar, window, hydro, or fossil fuel based power generation (and can include measures that restrain or restrict demand) or network communications and allocation to wired or wireless links.

The problem can be formally defined as follows.

Problem 1 (Value At Risk Optimization). Given risk level α and item loss density ƒ_{L} (l), let ƒ_{Y}(y|w) be the density of the portfolio loss

$$Y = {\sum }_{n = 1}^{K} {w}_{n} {L}_{n}$$

and F_{Y}(y|w) its associated CDF. The allocation strategy optimizing VaR_{α}(Y|w) is defined as

$${w}^{*} = {arg min}_{w} {F}_{Y}^{- 1} ( 1 - α \vert w ) \\ subject to \\ Aw \leq b$$

where the requirement for w to lie on the K−1-simplex has been absorbed into the constraints.

### 1.3 Parametrizing the Allocation Strategy

While the requirement for w to lie on the K−1-simplex can obviously be expressed in terms of K+1 linear inequality constraints, it is often convenient to keep the number of such explicit constraints as small as possible. To that end, we rely on logistic parametrization of the strategy. More specifically, given θ∈ [symbol] ^{K-1}

w: [symbol] ^{K-1}→Δ^{K-1}

with w(θ) given by

$${w}_{l} ( θ ) = \{ \begin{matrix}\frac{{e}^{{θ}_{l}}}{{\sum }_{{l}^{′} = 1}^{K - 1} {e}^{{θ}_{{l}^{′}}} + 1} & for l \leq K - 1 \\ \frac{1}{{\sum }_{{l}^{′} = 1}^{K - 1} {e}^{{θ}_{{l}^{′}}} + 1} & for l = K\end{matrix} \qquad ( 3 )$$

This parametrization has the effect that if, for example no auxiliary constraints on the strategy components are present, the optimization task is reduced to solving an unconstrained problem over [symbol] ^{K-1}.

Later on, we will require K×(K−1) Jacobian matrix of w

∂w/∂θ

whose elements can be shown from the definition in (3) to be

$$\frac{\partial {w}_{n}}{\partial {θ}_{m}} = \{ \begin{matrix}{w}_{n} ( θ ) - {w}_{m}^{2} ( θ ) & if n = m ( ⇒ n \leq K - 1 ) \\ - {w}_{n} ( θ ) {w}_{m} ( θ ) & if n \neq m ( including n = K )\end{matrix} \qquad ( 4 )$$

In what follows, all strategy-dependent constructs will be expressed in terms of θ rather than w (e.g. F_{Y}(y|θ) instead of F_{Y}(y|w) and so on). Further, we will refer to both w and θ as allocation strategies where there is no ambiguity as w(θ) is an injective function. The VaR problem (1) is then equivalently expressed as

$${θ}^{*} = {arg min}_{θ ∈ {ℝ}^{K - 1}} {F}_{Y}^{- 1} ( 1 - α \vert θ ) \\ subject to \\ Aw ( θ ) \leq b \qquad ( 5 )$$

### 1.4 Issue 1: F_{Y}(y|θ) is Unknown

Problem (1) and its reparameterization (5) pose well-defined optimization tasks, but an obvious issue with them is, of course that f_{L} is generally unknown or potentially very complex (e.g. involving non-trivial correlations among the components or with potentially heavy-tailed marginal densities), and that consequently f_{Y} (.|θ) and F_{Y}(.|θ) are either unknown or too difficult to represent analytically. It may be tempting to make simplifying assumptions about f_{L}; if for example L is considered to be normally-distributed with some (estimated) mean vector and covariance matrix, ƒ_{Y} will also be Gaussian with mean and variance following directly from ƒ_{L}'sparameters by the well-known properties of linear transformations of Gaussian variates. Such assumptions may yield useful insights about the task, but they can often be extremely inaccurate in practice; their usage in the wild is hence rightly considered reckless. In this work, we sidestep the issue of inferring ƒ_{L} by focusing directly on approximately representing the univariate loss density ƒ_{Y} at a given strategy nonparametrically, i.e. without assuming its form, from a set of N item loss observations {L¹, ... , L^{N}} (samples from ƒ_{L}) gathered over some relevant historical time period. As detailed in Section 2, these are used to approximate ƒ_{Y} with a kernel density estimate (KDE)

g_{Y}(y|θ)≈ƒ_{Y}(y|θ)

and subsequentialy, the CDF

G_{Y}(y|θ)=∫_{-∞}^{y}g_{Y}(t|θ)dt≈F_{Y}(y|θ) (6)

### 1.5 Issue 2: The VaR Gradient is Not Apparant

While nonparametric approximation of the portfolio loss density at a fixed θ from which the VaR can be obtained either analytically or by numerical root-finding techniques, is rather obvious, our problem is more demanding: finding the smallest VaR from among all densities identified with feasible {θ}. But most state-of-the-art algorithms for optimizing constrained nonlinear objectives require access to not only the objective (in this case VaR,) but also to its gradient with respect to the decision variables θ:

$$\frac{\partial }{\partial θ} {VaR}_{α} ( Y \vert θ )$$

This requirement exposes a potentially serious stumbling block, however; overcoming this obstacle is the main insight allowing the machinery and ideas in our work to be practical. In particular, we note that while the KDE yields straightforward estimates of ƒ_{Y}(y|θ) and F_{Y}(y|θ) as explicit functions of θ in turn allowing

$$\frac{\partial }{\partial θ} {F}_{Y} ( y \vert θ ) = {\int }_{- ∞}^{y} \frac{\partial }{\partial θ} {f}_{Y} ( t \vert θ ) dt$$

to be approximated at any y as a function of θ (possibly using numerical quadrature), the required gradient is that of the inverse of F_{Y}. Unfortunately, obtaining a closed-form expression for G_{Y}⁻¹ from that of G_{Y} is generally not possible. One potential route around this issue is to rely on finite-difference approximation; more specifically at a given θ the n^{th} component of the VaR gradient is approximated via

$$\frac{\partial }{\partial {θ}_{n}} {F}_{Y}^{- 1} ( 1 - α \vert θ ) \approx \frac{\begin{matrix}{F}_{Y}^{- 1} ( 1 - α \vert {θ}_{1} , … , {θ}_{n} + Δ , … , {θ}_{K - 1} ) - \\ {F}_{Y}^{- 1} ( 1 - α \vert {θ}_{1} , … , {θ}_{n} - Δ , … , {θ}_{K - 1} )\end{matrix}}{2 Δ} \qquad ( 7 )$$

for small perturbation value Δ. As for any arbitrary strategy θ, the two terms in the numerator of Eq. (7) must generally be obtained from the KDE-derived estimate of F_{Y}(y|θ) by numerical root-finding, in particular by solving equations of the form

G_{Y}(y|θ₁, . . . , θₙ+Δ, . . . , θ_{K-1})=1−α

G_{Y}(y|θ₁, . . . , θₙ−Δ, . . . , θ_{K-1})=1−α

in y at the requisite perturbed strategies. It is not hard to see that such an approach becomes impractically slow for large K because each approximate gradient evaluation, of which many are generally required over the course of an optimization routine, would require a total of 2(K−1) root-finding runs; the VaR at θ itself, however, only requires a single such run. A popular class of methods for mitigating this issue is known as simultaneous perturbation stochastic approximation (SPSA) which rely on a single random perturbation to obtain gradient estimates. Unfortunately the resultant estimates often have excessive variance, rendering them unsuitable for optimization algorithms more sophisticated than noisy gradient descent.

It turns out, however, that finite-differencing is not necessary to obtain the gradient; we derive a mathematical expression relating the gradient of the inverse of a function with respect to its parameters to that of the gradient of the function itself, a property which dramatically simplifies evaluation of the gradient. In addition, unlike the finite-difference approximation, the relation is exact. To avoid confusion with the inverse function theorem of calculus, we call the idea, described in the following Lemma, the inverse gradient trick.

Lemma 1 (Inverse Gradient Trick). Given a differentiable map T(x, θ): [symbol] ^{m+n}→ [symbol] ^{m} with x∈ [symbol] ^{m}, θ∈ [symbol] ⁿ such that for any θ∈ [symbol] ⁿT(x,θ) is invertible in x, we have

$$\frac{\partial {T}^{- 1}}{\partial θ} ( T ( x , θ ) , θ ) = - {[ \frac{\partial T}{\partial x} ( x , θ ) ]}^{- 1} \frac{\partial T}{\partial θ} ( x , θ ) \qquad ( 8 )$$

Proof. See Appendix A

A special case of Lemma 1, obtained when q=F_{Y}(y|θ) is the univariate (m=1) function playing the role of T (with y⇔x and n=K−1), is the simple result underlying our optimization procedures, as it relates the VaR gradient to that of the portfolio loss CDF.

Corollary 1 (VaR Inverse Gradient). If y_{α}=VaR_{α}(Y|θ)=F_{Y}⁻¹1−α|θ) then

$$\frac{\partial }{\partial θ} {VaR}_{α} ( Y \vert θ ) = \frac{- \frac{\partial }{\partial θ} {F}_{Y} ( {y}_{α} \vert θ )}{{f}_{Y} ( {y}_{α} \vert θ )}$$

In the following section, the ideas outlined so far will be made more concrete under a specific type of KDE.

### 2 Nonparametric VaR Formulation and its Gradient

Given the item loss observations {L¹, . . . , L^{N}}, strategy θ yields a set of N portfolio loss observations

$${Y}^{i} = {\sum }_{n = 1}^{K} {w}_{n} ( θ ) {L}_{n}^{i}$$

assumed to arise from ƒ_{Y}(.|θ). A KDE approximating ƒ_{Y} is a function of the form

$${ℊ}_{Y} ( y \vert θ , h ) = \frac{1}{N} {\sum }_{i = 1}^{N} {k}_{i} ( y \vert h )$$

where each data point contributes kernel function kᵢ to the estimate and h is a data-dependent smoothing parameter known as the bandwidth. In this work, we use the well-studied Gaussian KDE (not to be confused with the Gaussian mixture model) in which the kernel components are

$${k}_{i} ( y \vert v ) = \frac{1}{\sqrt{2 π v}} {e}^{- \frac{1}{2 v} {( y - {y}^{i} )}^{2}} \qquad ( 9 )$$

where we somewhat unconventionally refer to v as the bandwidth. The CDF of the Gaussian KDE is then given by

$${G}_{Y} ( y \vert θ , v ) = \frac{1}{N} {\sum }_{i = 1}^{N} Φ ( \frac{y - {y}^{i}}{\sqrt{v}} ) \qquad ( 10 )$$

where Φ(x) is the CDF of a standard Gaussian density, namely

$$Φ ( x ) = \frac{1}{\sqrt{2 π}} {\int }_{- ∞}^{x} {e}^{- {t}^{2}} dt = \frac{1}{2} [ 1 + erf ( \frac{x}{\sqrt{2}} ) ]$$

Though conceptually quite accessible as a smooth generalization of a histogram estimator, the accuracy of a KDE is critically dependent on both the bandwidth ν and how heavy-tailed the underlying true distribution ƒ_{Y} is. Concerning the former, if ν is too large, then fine-grained features present in ƒ_{Y} are obscured, while if it is too small an unduly “rugged” estimate consisting of spurious peaks and troughs results; these two extremes are respectively the nonparametric incarnations of under- and over-fitting encountered through-out statistics and machine learning. On the other hand, while it may seem obvious that the Gaussian KDE will yield poor estimates outside the data support under heavy-tailed ƒ_{Y} since it diminishes exponentially while by definition, a heavy-tailed density does not, it can also degrade within the support due to the spacing between the points being larger than a reasonably-chosen bandwidth aimed at working well over the whole data range. The bandwidth is generally chosen in a data-dependent manner, implying that in our context, it is a function of θ. Bandwidth selection is discussed in detail in Section 3.

Data transformations are a common strategy for dealing with heavy-tailed distributions in KDE settings. For any differentiable and invertible function t(y) assumed here without loss of generality to be strictly increasing, if Z=t(Y) and

Z˜ƒ_{z}

then

F_{Y}(y)=F_{z}(t)y)) (11)

and the well-known change-of-measure expression yields

ƒ_{Y}(y)=t′(y)ƒ_{z}(t)(y)) (12)

This is advantageous because many heavy-tailed distributions yield densities with exponentially decaying counterparts under appropriate transformation. For example taking the logarithm of a Pareto random variable Y results in an exponentially-distributed Z, and somewhat vacuously, the logarithm of log-normally-distributed Y results in ƒ_{z} being Gaussian. As a result, much more accurate KDEs are possible for heavy-tailed Y by computing ƒ_{z} using the transformed data points and inferring ƒ_{Y} using (12). Mathematically, data transformations are advantageous when the bias they introduce is small compared to the variance they attenuate. In addition to the transform z=log(y) for strictly positive losses, a function useful for losses assuming positive and negative values is the hyperbolic aresine transform:

t(y)=arc sinh(y)=log(y+\sqrt{y²+1})

It is crucial to note that KDEs on transformed data do not constitute bases for acceptable large deviations or extremal value inferences; in other words, the form of the KDE outside the data support cannot be taken to be accurate. Such an undertaking necessitates a parametric or functional assumption on the form of ƒ_{Y} or ƒ_{z}'s tail and, due to the nature of the task, is not considered in the present work. This is because in most financial applications, α is at least 0.01 or so and thus the VaR is typically within the frequency in which it occurs in the data, where it is common to have N≥10⁴.

In all that follows, we assume that a transformation (possibly t(y)= [symbol] (y), the identity function) has been applied to the losses prior to performing the KDE, i.e. the item loss-derived estimates are g_{z} and G_{z} constructed using specific samples {z¹(θ), . . . , z^{N} (θ)}, where

$${𝓏}^{i} ( θ ) = t [ {\sum }_{n = 1}^{K} {w}_{n} ( θ ) {l}_{n}^{i} ]$$

and from which g_{Y} and G_{Y} can be recovered mathematically.

To keep the exact and approximate optimization objectives conceptually distinct, we define the true and KDE-derived VaR and associated gradients under transformations.

### Exact VaR and Gradient

If y_{α}=VaR_{α}(Y)=F_{Y}⁻¹(1−α|θ), then under the transformation Z=t(Y), y_{α}=t⁻¹[F_{Z}⁻¹(1−α|θ))], abd Corollary 1 along with (11) and (12) imply that the gradient of the VAR when using transformed portfolio losses is

$$\frac{\partial }{\partial θ} {VaR}_{α} ( Y \vert θ ) = \frac{- \frac{\partial }{\partial θ} {F}_{Z} ( t ( {y}_{α} ) \vert θ )}{{t}^{′} ( {y}_{α} ) {f}_{Z} ( t ( {y}_{α} ) \vert θ )} \qquad ( 13 )$$

### Approximate VaR and Gradient

Define the approximate (KDE-based) VaR:

y_{α}= [symbol] (Y|θ)=G_{Y}⁻¹(1−α|θ, ν(θ))

If Z=t(Y) so that y_{α}=t⁻¹[G_{Z}⁻¹(1−α|θ, ν(θ))], analogy to the exact case yields the gradient

$$\frac{\partial }{\partial θ} ( Y \vert θ ) = \frac{- \frac{\partial }{\partial θ} {G}_{Z} ( t ( {y}_{α} ) \vert θ , v ( θ ) )}{{t}^{′} ( {y}_{α} ) {ℊ}_{Z} ( t ( {y}_{α} ) \vert θ , v ( θ ) )} \qquad ( 14 )$$

In general G_{Z}⁻¹(1−α|ƒ, ν(θ)) defining y_{α} must be evaluated numerically, in particular by solving for z such that

$$\frac{1}{N} {\sum }_{i = 1}^{N} Φ ( \frac{𝓏 - {𝓏}^{i}}{\sqrt{v}} ) = 1 - α$$

It is important to note that the bandwidth ν(θ) is not static through the optimization because each value of θ will induce a different portfolio loss density, in turn demanding a different optimal bandwidth for its estimation.

Since g_{Z} in the denominator of (14) is immediately available from the KDE, it remains to specify the gradient in its numerator. By the chain rule, we have

$$\frac{\partial }{\partial θ} {G}_{Z} ( z \vert θ , v ( θ ) ) = \frac{\partial {G}_{Z} ( z \vert θ , v )}{\partial θ} + \frac{\partial {G}_{Z} ( z \vert θ , v )}{\partial v} \frac{\partial v ( θ )}{\partial θ} \qquad ( 15 )$$

and so in turn, we are required to determine its three required partial derivatives. We presently discuss the first two of these functions, postponing the bandwidth gradient until we discuss the bandwidth itself in Section 3.

### Lemma 2. For a Gaussian KDE

$${ℊ}_{Z} ( z \vert θ ) = \frac{1}{N \sqrt{2 π v ( θ )}} {\sum }_{i = 1}^{N} {e}^{- \frac{1}{2 v ( θ )} {( 𝓏 - {𝓏}^{i} ( θ ) )}^{2}}$$

constructed using {zⁱ(θ)}, where

$${𝓏}^{i} ( θ ) = t [ {\sum }_{n = 1}^{K} {w}_{n} ( θ ) {l}_{n}^{i} ]$$

and {Lⁱ=lⁱ} are the observed item losses, we have

$$\frac{\partial {G}_{Z} ( z \vert θ , v )}{\partial θ} = \frac{- 1}{N \sqrt{2 π v}} {\sum }_{i = 1}^{N} \frac{\partial {𝓏}^{i}}{\partial θ} {e}^{- \frac{1}{2 v} {( 𝓏 - {𝓏}^{i} ( θ ) )}^{2}} \qquad ( 16 )$$

$$\frac{\partial {G}_{Z} ( z \vert θ , v )}{\partial v} = \frac{- 1}{2 N {v}^{3 / 2} \sqrt{2 π}} {\sum }_{i = 1}^{N} ( 𝓏 - {𝓏}^{i} ( θ ) ) {e}^{- \frac{1}{2 v} {( 𝓏 - {𝓏}^{i} ( θ ) )}^{2}} \qquad ( 17 )$$

Proof. See Appendix B

Before passing on to the question of bandwidth selection, we note that component (16) has the form of a Jacobian-vector product often encountered in statistics and machine learning. In particular, if we form the N×(K−1) Jacobian matrix of the transformed portfolio losses

$$\frac{\partial z}{\partial θ}$$

whose i^{th} row consists of the gradient

$${( \frac{\partial {z}_{i}}{\partial θ} )}^{T}$$

and the vector u(z), with

$${u}_{i} ( z ) = \frac{1}{2 π v} {e}^{- \frac{1}{2 v} {( z - {z}^{i} ( θ ) )}^{2}} ,$$

we can write

$$\frac{\partial {G}_{Z} ( z \vert θ , v )}{\partial θ} = - {( \frac{\partial z}{\partial θ} )}^{T} u ( z )$$

pointing to a mode for computational acceleration via GPU-enabled linear algebra routines.

### 3 Bandwidth Selection and Backpropagation

An appealing and entirely data-dependent approach to selecting ν(θ) is that of cross-validation; in particular, a validation loss is defined corresponding to the predictive error (for example mean-squared, or log likelihood) of a KDE constructed using all but one of the points, for each point, at a given bandwidth. The cross-validated bandwidth is defined to be the one that yields the smallest predictive loss. For example, the validation log loss at bandwidth value \tilde{ν} is given by

$$ℒ ( \tilde{v} ; \{ {z}^{i} \} ) = - \frac{1}{N} {\sum }_{i = 1}^{N} log ( {g}_{Z} ( {z}^{i} \vert \{ {z}^{j} \} / {z}^{i} , \tilde{v} ) )$$

The cross-validated bandwidth is thus

$${v}_{c v} ( θ ) = {argmin}_{\tilde{v}} ℒ ( \tilde{v} ; \{ {z}^{i} ( θ ) \} )$$

One obvious issue with the usage of such a scheme is its computational expense. For example a naive evaluation of the loss requires O(N²) effort because the KDE must be computed N times, with each computation comprised of a summation over N−1 terms; to make matters worse, the loss must generally be evaluated many times over the course of obtaining ν_{cv}. Remarkably, this cost can be dramatically reduced using a combination of clever algorithmic and mathematical insights; in particular, all needed costs can be reduced to being O(N) at the expense of a minor loss in precision.

A more serious problem however, is that the validation loss is generally not convex in \tilde{ν}. This in turn implies that the arg min operation present in the definition of ν_{cv}(θ) can cause the bandwidth to jump discontinuously, so that there are points in the strategy space that cause ∂ν_{cv}/∂θ to become infinite. This is a serious problem for many optimization algorithms and interestingly, is a direct analog to the phenomena of first order phase transitions in physics, which are known to be associated with computational challenges. As a result, we do not consider cross-validated bandwidth selection in this work, but rather focus on prescribed formulae immune to this issue.

The Silverman estimator is a well-studied choice for the Gaussian KDE bandwidth, adapted for present purposes as

$${v}_{s i l v} ( θ ) {=}^{Δ} {( \frac{4}{3 N} )}^{2 / 5} {\hat{σ}}^{2} ( θ ) \qquad ( 18 )$$

where \hat{σ}²(θ) is the empirical data variance

$${\hat{σ}}^{2} ( θ ) = \frac{1}{N} {\sum }_{i = 1}^{N} {{z}^{i} ( θ )}^{2} - {\frac{1}{{N}^{2}} [ {\sum }_{i = 1}^{N} {z}^{i} ( θ ) ]}^{2}$$

This implies that the gradiant ∂νₛᵢₗᵥ/∂θ is easy to obtain because it is simply a constant scaling the data variance, whose gradient is given by

$$\frac{\partial {\hat{σ}}^{2}}{\partial θ} = \frac{2}{N} {\sum }_{i = 1}^{N} {z}^{i} ( θ ) \frac{\partial {z}^{i}}{\partial θ} - \frac{2}{{N}^{2}} ( {\sum }_{i = 1}^{N} {z}^{i} ( θ ) ) ( {\sum }_{i = 1}^{N} \frac{\partial {z}^{i}}{\partial θ} ) \qquad ( 19 )$$

The Silverman estimator has been proved to be optimal if the true distribution is Gaussian but can perform poorly if this assumption is violated. In particular, multimodality, skewness, and heavy tails will all render it suboptimal, usually through its prescription of an over-smoothing bandwidth. Short of selecting the width via assumption-free cross-validation, a compromise modification is to base it not only on the data variance but on its interquartile range, i.e. the distance between the data's 0.25 and 0.75 quantiles. Specifically, we define this bandwidth to be

$${v}_{i q r} ( θ ) {=}^{Δ} {( \frac{0.9}{{N}^{1 / 5}} )}^{2} min ( {\hat{σ}}^{2} ( θ ) , \frac{I Q {R}^{2} ( θ )}{{1.34}^{2}} ) \qquad ( 20 )$$

The bandwidth gradient under this choice is thus given by

$$\frac{\partial {v}_{i q r}}{\partial θ} = {( \frac{0.9}{{N}^{1 / 5}} )}^{2} \times \{ \begin{matrix}\frac{\partial \hat{σ}}{\partial θ} & if {\hat{σ}}^{2} < {( \frac{I Q R}{1.34} )}^{2} \\ \frac{\partial }{\partial θ} {( \frac{I Q R}{1.34} )}^{2} & if {\hat{σ}}^{2} \geq {( \frac{I Q R}{1.34} )}^{2}\end{matrix} \qquad ( 21 )$$

where the variance gradient is as defined in (19).

Note that while θ_{iqr}(θ) is a continuous function under our assumptions, it is no longer smooth. This is generally not a serious obstacle to optimization and can be handled in one of several ways. One conceptually simple method is to replace the minimization in (20) by the softmin function at parameter value β>0

$$s ( x , y ; β ) {=}^{Δ} - \frac{1}{β} log ( {e}^{- β x} + {e}^{- β y} )$$

and to modify the gradient (21) appropriately. The value of β is typically “annealed” over the optimization such that at its final value, it is large enough to effectively render s(x, y; β)≈min(x, y). Remarkably however, several optimization algorithms (e.g. quasi-Newton methods) that assume smoothness often work well in practice on non-smooth problems without modification!

A somewhat glaring question presents itself under bandwidth scheme (20) however. If the task were merely density estimation, the IQR could simply be approximated using the data order statistics, i.e. by taking the difference between the └0.75N^{th}┘ and └0.25N^{th}┘ largest data points. Our optimization problem is more demanding; we also require the gradient of the IQR with respect to θ. To that end, we propose to bootstrap the Silverman estimator into the following hierarchical approach. Consider the KDE constructed using the Silverman bandwidth, i.e

g_{Z}(z|θ, νₛᵢₗᵥ(θ))

with its associated CDF and quantile function. We define the IQR function to be

IQR(θ) [symbol] G_{Z}⁻¹(0.75|θ, νₛᵢₗᵥ(θ))−G_{Z}⁻¹(0.25|θ, νₛᵢₗᵥ(θ))

The ever-useful inverse gradient trick returns to our aid here, giving us

$$\frac{\partial }{\partial θ} IQR ( θ ) = \frac{- \frac{\partial }{\partial θ} {G}_{Z} ( {z}_{0.75} \vert θ , {v}_{silv} ( θ ) )}{{g}_{Z} ( {z}_{0.75} \vert θ , {v}_{silv} ( θ ) )} - \frac{- \frac{\partial }{\partial θ} {G}_{Z} ( {z}_{0.25} \vert θ , {v}_{silv} ( θ ) )}{{g}_{Z} ( {z}_{0.25} \vert θ , {v}_{silv} ( θ ) )} \qquad ( 22 )$$

The procedure for obtaining the required partials is identical to that used in the main VaR backpropagation described in Section 2. For example, to compute

$$\frac{\partial }{\partial θ} {G}_{Z} ( {z}_{0.75} \vert θ , {v}_{s i l v} ( θ ) )$$

we first numerically solve for z_{0.75} as the value satisfying

G_{Z}(z|θ, νₛᵢₗᵥ(θ))=0.75

and then obtain the required gradient as

$$\frac{\partial }{\partial θ} {G}_{Z} ( {z}_{0.75} \vert θ , {v}_{s i l v} ( θ ) ) = \frac{\partial {G}_{Z} ( {z}_{0.75} \vert θ , {v}_{s i l v} )}{\partial θ} + \frac{\partial {G}_{Z} ( {z}_{0.75} \vert θ , v )}{\partial v} \frac{\partial {v}_{s i l v} ( θ )}{\partial θ}$$

where the first two partials were defined in Lemma 2 and the third was just discussed. The proposed Silverman bootstrap thus constitutes a “deep” extension of our original idea which enables more elaborate and appropriate data statistics than the variance to be used in nonparametrically optimizing the VaR.

Having suitably defined both the nonparametric VaR objective and its gradient under various modelling regimes, we are finally ready to discuss solving the optimization problem.

### 4 Optimization of the VaR by Sequential Quadratic Programming

Sequential Quadratic Programming (SQP), is a constrained generalization of Newton's method. More specifically, it is an iterative method for optimizing nonlinear objective functions with equality and inequality constraints by successively minimizing local quadratic approximations to the objective subject to linear approximations of the constraints. In other words, it solves a sequence of quadratic programs encoding “snapshots” of the original problem.

Consider the optimization problem

$${min}_{x} f ( x ) \\ subject to \\ g ( x ) \geq 0 \\ h ( x ) = 0$$

At step k of the SQP process, the current point xₖ defines the quadratic programming problem over the search direction pₖ as

$${min}_{p} f ( {x}_{k} ) + ∇ {f ( {x}_{k} )}^{T} p + \frac{1}{2} {p}^{T} {∇}_{xx}^{2} ℒ ( {x}_{k} , {λ}_{k} , {v}_{k} ) p \\ subject to \\ g ( {x}_{k} ) + ∇ {g ( {x}_{k} )}^{T} p \geq 0 \\ h ( {x}_{k} ) + ∇ {h ( {x}_{k} )}^{T} p = 0$$

where [symbol] (x, λ, ν) is the Lagrangian function

[symbol]

(x, λ, ν)=ƒ(x)−λ^{T}g(x)−λ^{T}h(x)

Computing the Hessian of [symbol] as required by the SQP formulation is very computationally demanding; in practice, it is approximated using differences of gradients and is often enforced to be positive definite, as in quasi-Newton methods.

In the VaR optimization problem, our efforts to obtain the gradients of KDE-derived approximations to the portfolio loss are now well-rewarded in that standard SQP packages requiring access to both the objective and its gradient can be readily applied. Using our ideas, widely-available SQP packages are able to optimize the VaR corresponding to K=500 items using N=10⁴ observed items losses in a matter of a few minutes on standard laptop CPU hardware.

Our discussion so far has only considered linear portfolio and index inequality con- straints, which of course are no longer linear under the logistic parametrization of the strategy domain:

Aw(θ)≤b

It turns out however, that additional constraints may be desired due to their stabilizing influence on the optimization procedure.

### 4.1 Entropic Regularization

This section introduces a modification encouraging the allocation strategy to avoid being excessively “peaked” on any investment items, or equivalently, to reward closeness of to to the uniform distribution. We achieve this by adding a negative entropic regularization term to the VaR objective:

$$H ( θ ) {=}^{△} Γ {\sum }_{n = 1}^{K} {w}_{n} ( θ ) log {w}_{n} ( θ ) \qquad ( 23 )$$

for Γ≥0. For optimization, the gradient of this term is needed and given by

$$\frac{\partial H}{\partial θ} = Γ {\sum }_{n = 1}^{K} \frac{\partial {w}_{n}}{\partial θ} ( log {w}_{n} ( θ ) + 1 ) \qquad ( 24 )$$

where the strategy gradient terms were presented in (4). If Γ is sufficiently large, the VaR problem is effectively disregarded, yielding wₙ(θ)≈1/K for all n while if it is small enough the original problem is, of course recovered.

The advantage of augmenting the loss with H(0) is that a sequence of VaR problems may be defined, corresponding to decreasing values Γ, each of which begin their searches from their preceding problems' optimized strategies (“warm starting”) such that numerical issues due to ill-conditioning are mitigated. Note that entropic regularization is simply a modification to the cost function and does not introduce any new constraints.

### 4.2 Linear Bounds on θ

An alternative strategy in somewhat similar spirit to that of entropic regularization is iterative control over the range of allowable θ. One specific instance of this idea observed to be of considerable use on the VaR problem is to impose a linear upper bound on the magnitude of θ's components, i.e.

θₙ≤c for n∈{1, 2, . . . , K−1} (25)

and to solve a sequence of VaR problems corresponding to increasing (i.e. less constrained) values of c, with each problem again warm starting off its predecessor's solution.

This strategy addresses a problem we commonly observe when optimizing the VaR, ultimately arising because the problem is not convex: it is quite common for many seemingly reasonable initial parameter settings (e.g. θ≈0) to direct the optimization to spurious solutions in which some components are erroneously disregarded (i.e. have their wₙ set to zero). We observe that these are solutions are local minima corresponding to θ with relatively large components. Sequentially controlling the level of θ is seen to be quite effective in addressing this specific pitfall. It is worth mentioning that the first problem in the sequence (e.g. by setting c=0) tends to dominate the computational time, and that subsequent warm-started optimization runs with successively larger c converge to their solutions much more quickly.

### 5 Representative Methods

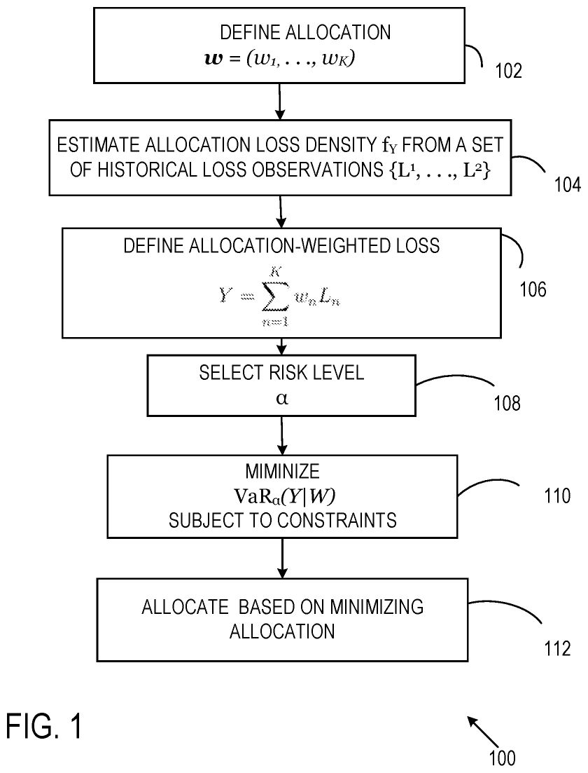

Referring to FIG. 1, a representative method 100 includes defining an allocation w=(w₁, . . . , w_{K}) at 102 based on a set of K resources. At 104, an allocation loss density ƒ_{Y} is estimated from a set of historical loss observations L=(L 1 , . . . , L K). An allocation weighted loss Y is defined at 106 as Y=Σₙ₌₁^{K} wₙLₙ. A risk level α is selected at 108. At 110, a value at risk VaR is minmized for the selected risk level, subject to any constraints. Finally, at 112, an allocation associated with the minimized risk is selected for item allocation.

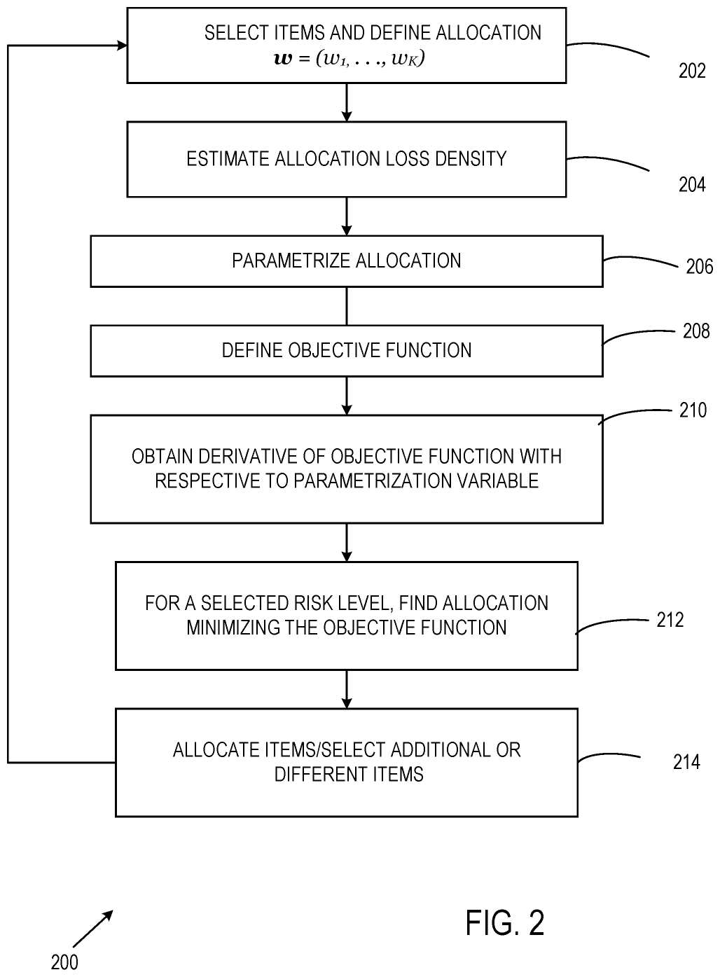

Referring to FIG. 2, a representative method 200 includes selecting items and defining an allocation to w=(w₁, . . . , w_{K}) at 202. At 204, an allocation loss density is estimated and at 206, the allocation w is parameterized. An objective function is defined at 201 and a derivative of the objective function is obtained at 210 based on a parametrization variable such as θ as discussed above. At 212, an allocation is computed for a selected risk level that minimizes the objective function. At 214, the selected allocation is implemented; alternatively, if the selected allocation is unacceptable, additional or fewer items can be include at 202 and the calculation repeated based on the alternative set of items.

### 6 Computing Environment

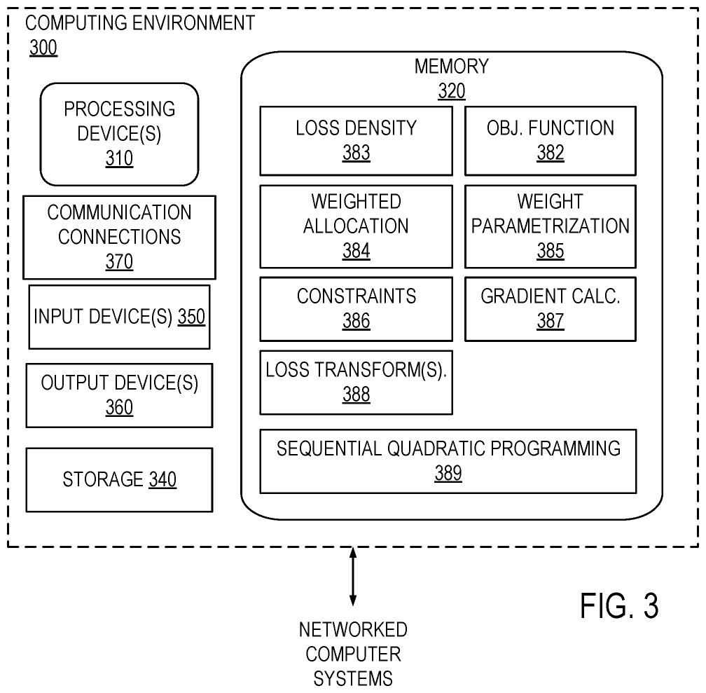

FIG. 3 illustrates a generalized example of a suitable computing environment 300 in which several of the described embodiments can be implemented. The computing environment 300 is not intended to suggest any limitation as to the scope of use or functionality of the disclosed technology, as the techniques and tools described herein can be implemented in diverse general-purpose or special-purpose environments that have computing hardware.

With reference to FIG. 3, the computing environment 300 includes at least one processing device 310 and memory 320. In FIG. 3, this most basic configuration 300 is included within a dashed line. The processing device 310 (e.g., a CPU or microprocessor) executes computer-executable instructions. In a multi-processing system, multiple processing devices execute computer-executable instructions to increase processing power. The memory 320 may be volatile memory (e.g., registers, cache, RAM, DRAM, SRAM), non-volatile memory (e.g., ROM, EEPROM, flash memory), or some combination of the two. The memory 320 stores software implementing tools for implementing embodiments of the disclosed technology. For example, the memory (e.g., any of the disclosed techniques for implementing error correcting qubits or generating codes for such circuits).

The computing environment can have additional features. For example, the computing environment 300 includes storage 340, one or more input devices 350, one or more output devices 360, and one or more communication connections 370. An interconnection mechanism (not shown), such as a bus, controller, or network, interconnects the components of the computing environment 300. Typically, operating system software (not shown) provides an operating environment for other software executing in the computing environment 300, and coordinates activities of the components of the computing environment 300.

The storage 340 can be removable or non-removable, and includes one or more magnetic disks (e.g., hard drives), solid state drives (e.g., flash drives), magnetic tapes or cassettes, CD-ROMs, DVDs, or any other tangible non-volatile storage medium which can be used to store information and which can be accessed within the computing environment 300. The storage 340 can also store instructions for the software generating or implementing the processor-executable instructions and/or storing data values as in the memory 320. As shown, the memory 320 stores instructions for determining objective functions at 382, loss density at 383, weighted allocations at 384, weight parametrization at 385, specifying constraints at 386, calculating gradients at 387, loss transforms at 388, and sequential quadratic programming at 389. The instructions and data can also be retained in the storage 340.

The input device(s) 350 can be a touch input device such as a keyboard, touch-screen, mouse, pen, trackball, a voice input device, a scanning device, or another device that provides input to the computing environment 300. The output device(s) 360 can be a display device (e.g., a computer monitor, laptop display, smartphone display, tablet display, netbook display, or touchscreen), printer, speaker, or another device that provides output from the computing environment 300.

The communication connection(s) 370 enable communication over a communication medium to another computing entity. The communication medium conveys information such as computer-executable instructions or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

As noted, the various methods and techniques for implementing the disclosed methods can be described in the general context of computer-readable instructions stored on one or more computer-readable media. Computer-readable media are any available media (e.g., memory or storage device) that can be accessed within or by a computing environment. Computer-readable media include tangible computer-readable memory or storage devices, such as memory 320 and/or storage 340, and do not include propagating carrier waves or signals per se (tangible computer-readable memory or storage devices do not include propagating carrier waves or signals per se).

Various embodiments of the methods disclosed herein can also be described in the general context of computer-executable instructions (such as those included in program modules) being executed in a computing environment by a processor. Generally, program modules include routines, programs, libraries, objects, classes, components, data structures, and so on, that perform particular tasks or implement particular abstract data types. The functionality of the program modules may be combined or split between program modules as desired in various embodiments. Computer-executable instructions for program modules may be executed within a local or distributed computing environment.

### Appendix A Proof of Lemma 1

For any θ, let y=T(x, θ) so that x=T⁻¹(y, θ), i.e.

T⁻¹(T(x, θ), θ)=x

Holding x constant and taking the gradient with respect to θ, we have

$$\frac{\partial }{\partial θ} {T}^{- 1} ( T ( x , θ ) , θ ) = 0$$

By the chain rule,

$$\frac{\partial }{\partial θ} {T}^{- 1} ( T ( x , θ ) , θ ) = \frac{\partial {T}^{- 1}}{\partial θ} ( T ( x , θ ) , θ ) + \frac{\partial {T}^{- 1}}{\partial y} ( T ( x , θ ) , θ ) \frac{\partial T}{\partial θ} ( x , θ ) \qquad ( 26 )$$

But the inverse function theorem states that

$$\frac{\partial {T}^{- 1}}{\partial y} ( y , θ ) = {[ \frac{\partial T}{\partial x} ( {T}^{- 1} ( y , θ ) , θ ) ]}^{- 1}$$

implying that

$$\frac{\partial {T}^{- 1}}{\partial θ} ( T ( x , θ ) , θ ) + {[ \frac{\partial T}{\partial x} ( x , θ ) ]}^{- 1} \frac{\partial T}{\partial θ} ( x , θ ) = 0$$

from which the result (8) follows.

### Appendix B Proof of Lemma 2

Note that

$$\begin{matrix}\frac{\partial {G}_{Z} ( z \vert θ , v )}{\partial θ} = \frac{1}{N \sqrt{2 π v}} {\int }_{- ∞}^{z} {\sum }_{i = 1}^{N} \frac{\partial }{\partial θ} {e}^{- \frac{1}{2 v} {( t - {z}^{i} ( θ ) )}^{2}} dt \\ = \frac{1}{N \sqrt{2 π} {v}^{3 / 2}} {\sum }_{i = 1}^{N} \frac{\partial {z}^{i}}{\partial θ} {\int }_{- ∞}^{z} ( t - {z}^{i} ( θ ) ) {e}^{- \frac{1}{2 v} {( t - {z}^{i} ( θ ) )}^{2}} dt\end{matrix} \qquad ( 27 )$$

$$But$$

$${\int }_{- ∞}^{z} ( t - {z}^{i} ( θ ) ) {e}^{- \frac{1}{2 v} {( t - {z}^{i} ( θ ) )}^{2}} dt = - {ve}^{- \frac{1}{2 v} {( z - {z}^{i} ( θ ) )}^{2}} \qquad ( 28 )$$

which with the preceding, imply the result (16).

The proof of (17) follows a similar scheme, but also invokes the straightforward properties of the error function.

What is claimed is:

1. An allocation method, comprising:
obtaining an objective function associated with resource allocation risk;
selecting an acceptable value of risk;
logistically parametrizing weights associated with the resource allocation;
estimating a gradient of the objective function based on a ratio of a derivative of a cumulative density to a loss density; and
obtaining a preferred allocation based on the estimated gradient and the acceptable value of risk.

2. The method of claim 1, wherein the preferred allocation is obtained using sequential quadratic programming based on the objective function and the gradient of the objective function.

3. The method of claim 1, wherein the resource allocation is based on K resources with respective weights w₁ for i=1, . . . , K, wherein l and K are positive integers and the weights are parametrized as:
$${w}_{l} ( θ ) = \{ \begin{matrix}\frac{{e}^{{θ}_{l}}}{{\sum }_{{l}^{′} = 1}^{K - 1} {e}^{{θ}_{{l}^{′}}} + 1} & for l \leq K - 1 \\ \frac{1}{{\sum }_{{l}^{′} = 1}^{K - 1} {e}^{{θ}_{{l}^{′}}} + 1} & for l = K\end{matrix} \qquad ( 29 )$$
wherein θ is set of K real numbers.

4. The method of claim 3, wherein the derivative of the objective function is based on differentiation with respect to θ.

5. The method of claim 1, wherein the estimating the gradient of the objective function is based on transformed losses associated with each of the resources.

6. The method of claim 5, wherein losses yₗ are transformed based on a logarithm function as log(yₗ).

7. The method of claim 5, wherein the losses yₗ are transformed based on a hyperbolic arc sinh function as arc sinh(yₗ).

8. The method of claim 1, wherein the allocation strategy is defined by an integer number K of weights w for each of K items as
$$w = ( {w}_{1} , … , {w}_{K} ) \\ {w}_{n} \geq 0 for n ∈ \{ 1 , … , K \} \\ {\sum }_{n = 1}^{K} {w}_{n} = 1 \qquad ( 30 )$$
wherein wₙ specifyies an allocation fraction dedicated to item n.

9. The method of claim 8, wherein losses associated with each of the K items are defined by respective elements of a K-dimensional random variable L=(L₁, . . . , L_{K}).

10. The method of claim 9, wherein a weighted allocation loss Y is defined by
$$Y = {\sum }_{n = 1}^{K} {w}_{n} {L}_{n} \qquad ( 31 )$$
and the preferred allocation is selected to minimize the weighted allocation loss Y.

11. The method of claim 1, wherein the resources are power generation resources or network communication resources with respective risks associated with power shortfall and data loss.

12. An allocation system, comprising:
at least one processor; and
at least one computer readable storage medium having stored thereon processor-executable instructions to cause the processor to:
obtain an objective function associated with resource allocation risk;
logistically parametrize weights associated with the resource allocation;
estimate a gradient of the objective function based on a ratio of a derivative of a cumulative density to a loss density; and
obtain a preferred allocation based on the estimated gradient and the acceptable value of risk.

13. The allocation system of claim 12, wherein the at least one computer readable storage medium has stored thereon processor-executable instructions to cause the processor to obtain the preferred allocation using sequential quadratic programming.

14. The allocation system of claim 12, wherein the at least one computer readable storage medium has stored thereon processor-executable instructions to cause the processor to obtain the resource allocation of K resources with respective weights wₗ for i=1, . . . , wherein l and K are positive integers and the weights are parameterized as
$${w}_{l} ( θ ) = \{ \begin{matrix}\frac{{e}^{{θ}_{l}}}{{\sum }_{{l}^{′} = 1}^{K - 1} {e}^{{θ}_{{l}^{′}}} + 1} & for l \leq K - 1 \\ \frac{1}{{\sum }_{{l}^{′} = 1}^{K - 1} {e}^{{θ}_{{l}^{′}}} + 1} & for l = K\end{matrix} \qquad ( 32 )$$
wherein θ is set of K real numbers.

15. The allocation system of claim 12, wherein the at least one computer readable storage medium has stored thereon processor-executable instructions to cause the processor to obtain the derivative of the objective function based on differentiation with respect to θ.

16. The allocation system of claim 15, wherein the at least one computer readable storage medium has stored thereon processor-executable instructions to cause the processor to estimate the gradient of the objective function is based on transformed losses associated with each of the resources.

17. The allocation system of claim 12, wherein losses yᵢ are transformed based on a logarithm function as log(yₗ).

18. The allocation system of claim 12, wherein the losses yₗ are transformed based on a hyperbolic arc sinh function as arc sinh(yₗ).

19. The allocation system of claim 12, wherein:
the allocation strategy is defined by an integer number K of weights for each of K items as
$$w = ( {w}_{1} , … , {w}_{K} ) \\ {w}_{n} \geq 0 for n ∈ \{ 1 , … , K \} \\ {\sum }_{n = 1}^{K} {w}_{n} = 1 \qquad ( 33 )$$
wherein wₙ specifies an allocation fraction dedicated to item n;
losses associated with each of the K items are defined by respective elements of a K-dimensional random variable L=(L₁, . . . , L_{K});
a weighted allocation loss Y is defined by
$$Y = {\sum }_{n = 1}^{K} {w}_{n} {L}_{n} ; and \qquad ( 34 )$$
the preferred allocation is selected to minimize the weighted allocation loss Y.

20. The allocation system of claim 12, wherein the resources are power generation resources or network communication resources with respective risks associated with power shortfall and data loss.
